(19) United States
(12) Patent Application Publication
(10) Pub. No.: US 2026/0341143 A1
(43) Pub. Date: Oct. 29, 2026

(54) HAZARD MONITORING SYSTEM

(71) Applicant: Blue Origin Manufacturing, LLC, Huntsville, AL (US)

(72) Inventor: Alex S. Goldberg, Kent, WA (US)

(21) Appl. No.: 19/190,360

(22) Filed: Apr. 25, 2025

(51) Int. Cl. G08B 21/22; G08B 21/02

(52) U.S. Cl. CPC G08B 21/22; G08B 21/02

(57) ABSTRACT

Embodiments of the present disclosure are generally directed to a hazard monitoring system for monitoring potentially hazardous sites, such as a launch site, and informing on actual hazardous conditions. The hazard monitoring system can generate a graphical interface to communicate the hazard conditions to users in real-time.

### BACKGROUND

Sites, such as rocket launch sites, can incur hazardous conditions. Previous methods for identifying hazards at a launch site would been done verbally, in launch procedures and flight rules, using paper-based maps with simple shape file overlays. A range master at the launch site would get on a loudspeaker and describe the current hazard condition status. There are many different hazard conditions and knowing what areas are free to roam, hazardous, and off-limits can be difficult for personnel and can result in safety risks.

### SUMMARY OF EMBODIMENTS

The systems, methods, and devices of this disclosure each have several innovative aspects, no single one of which is solely responsible for all of the desirable attributes disclosed herein.

In some aspects, the techniques described herein relate to a system for hazard analysis at a launch site, the system including: a non-transitory computer storage medium configured to at least store computer-executable instructions; and one or more hardware processors in communication with the non-transitory computer storage medium, the computer-executable instructions, when executed by the one or more hardware processors, cause the one or more hardware processors to: receive site data associated with a launch site, wherein the site data includes location data and operational data associated with a plurality of static physical entities and a plurality of dynamic physical entities at the launch site; access a first hazard overlay associated with the launch site, wherein the first hazard overlay divides at least a portion of the launch site into a plurality of hazard zones, wherein the first hazard overlay is associated with a first hazard type, wherein each hazard zone is associated with a hazard state; determine a hazard state for each hazard zone, wherein the determination of the hazard state includes: determine a first subset of entities associated with the hazard zone, wherein the first subset of entities includes at least one of a static virtual entity of the plurality of static physical entities or a dynamic virtual entity of the plurality of dynamic physical entities; determine interactions between the first subset of entities based at least in part on the first hazard type; determine a hazard score for the hazard zone based at least in part on the determined interactions between the first subset of entities; and output the hazard state based at least in part on the hazard score; and output instructions to display visual indications associated with the determined hazard states.

In some aspects, the techniques described herein relate to a system, wherein the hazard score further includes hazard output data associated with the determination of the hazard score.

In some aspects, the techniques described herein relate to a system, wherein the hazard state is one of a plurality of discrete classifications.

In some aspects, the techniques described herein relate to a system, wherein each of the plurality of discrete classifications is associated with a different visual indication.

In some aspects, the techniques described herein relate to a system, wherein the site data further includes auxiliary data, and wherein the determination of the hazard score is further based at least in part on the auxiliary data, wherein the auxiliary data includes at least one of hazardous event data or weather data.

In some aspects, the techniques described herein relate to a system, wherein the first subset of entities include static entities and dynamic entities that are located outside of the hazard zone.

In some aspects, the techniques described herein relate to a system, wherein the hazard state for each hazard zone is determined independently.

In some aspects, the techniques described herein relate to a system, wherein the determination of a hazard state for each hazard zone is determined using a machine learning model associated with the first hazard type.

In some aspects, the techniques described herein relate to a system, wherein the computer-executable instructions, when executed, further cause the one or more hardware processors to: access a second hazard overlay associated with the launch site, wherein the second hazard overlay divides at least a portion of the launch site into a plurality of hazard zones, wherein the second hazard overlay is associated with a second hazard type, wherein the determination of a hazard state for each hazard zone associated with the second overlay is determined using a machine learning model associated with the second hazard type.

In some aspects, the techniques described herein relate to a system, wherein the site data is received in real-time from the launch site, and the determination of a hazard state for each hazard zone is determined in real-time.

In some aspects, the techniques described herein relate to a method for hazard analysis at a launch site, the method including: receiving site data associated with a launch site, wherein the site data includes location data and operational data associated with a plurality of static physical entities and a plurality of dynamic physical entities at the launch site; accessing a first hazard overlay associated with the launch site, wherein the first hazard overlay divides at least a portion of the launch site into a plurality of hazard zones, wherein the first hazard overlay is associated with a first hazard type, wherein each hazard zone is associated with a hazard state; determining a hazard state for each hazard zone, wherein the determination of the hazard state includes: determining a first subset of entities associated with the hazard zone, wherein the first subset of entities includes at least one of a static virtual entity of the plurality of static physical entities or a dynamic virtual entity of the plurality of dynamic physical entities; determining interactions between the first subset of entities based at least in part on the first hazard type; determining a hazard score for the hazard zone based at least in part on the determined interactions between the first subset of entities; and outputting the hazard state based at least in part on the hazard score; and outputting instructions to display visual indications associated with the determined hazard states.

In some aspects, the techniques described herein relate to a method, wherein the hazard score further includes hazard output data associated with the determination of the hazard score.

In some aspects, the techniques described herein relate to a method, wherein the hazard state is one of a plurality of discrete classifications.

In some aspects, the techniques described herein relate to a method, wherein each of the plurality of discrete classifications is associated with a different visual indication.

In some aspects, the techniques described herein relate to a method, wherein the site data further includes auxiliary data, and wherein the determination of the hazard score is further based at least in part on the auxiliary data, wherein the auxiliary data includes at least one of hazardous event data or weather data.

In some aspects, the techniques described herein relate to a method, wherein the first subset of entities include static entities and dynamic entities that are located outside of the hazard zone.

In some aspects, the techniques described herein relate to a method, wherein the hazard state for each hazard zone is determined independently.

In some aspects, the techniques described herein relate to a method, wherein the determination of a hazard state for each hazard zone is determined using a machine learning model associated with the first hazard type.

In some aspects, the techniques described herein relate to a method further including: accessing a second hazard overlay associated with the launch site, wherein the second hazard overlay divides at least a portion of the launch site into a plurality of hazard zones, wherein the second hazard overlay is associated with a second hazard type, wherein the determination of a hazard state for each hazard zone associated with the second overlay is determined using a machine learning model associated with the second hazard type.

In some aspects, the techniques described herein relate to a method, wherein the site data is received in real-time from the launch site, and the determination of a hazard state for each hazard zone is determined in real-time.

### BRIEF DESCRIPTION OF THE DRAWINGS

These and other features, aspects, and advantages of the present application are described with reference to drawings of certain embodiments, which are intended to illustrate, but not limit, the present disclosure. It is to be understood that the attached drawings are for the purpose of illustrating concepts disclosed in the present application and may not be to scale.

Throughout the drawings, reference numbers are re-used to indicate correspondence between referenced elements. The drawings are provided to illustrate embodiments of the subject matter described herein and do not limit the scope thereof.

FIG. 1 illustrates an embodiment of a networked computing environment that can implement one or more embodiments of a hazard monitoring system.

FIG. 2 illustrates as embodiment of a hazard monitoring system.

FIG. 3A illustrates an example of a launch site.

FIG. 3B illustrates an example of a virtual representation of the launch site of FIG. 3A.

FIGS. 4A-4B illustrate examples of a hazard overlay on the virtual representation of the launch site.

FIG. 5 illustrates a flowchart of an embodiment of a process for generating a virtual representation of a launch site.

FIG. 6 illustrates a flowchart of an embodiment of a process for monitoring the launch site and updating the virtual representation of the launch site.

FIG. 7 illustrates a flowchart of an embodiment of a process for performing a hazard analysis of the virtual representation of a launch site.

FIG. 8 illustrates an embodiment of a computing device.

### DETAILED DESCRIPTION

### Overview

Embodiments of the present disclosure are generally directed to a hazard monitoring system for monitoring potentially hazardous sites, such as a launch site, and informing on actual hazardous conditions.

The hazard monitoring system can be configured to generate a digital twin of the launch site. The digital twin can be a virtual representation of the launch site. The digital twin can model the type, size, and location of physical equipment and facilities present at the launch site. The hazard monitoring system can be configured to determine hazardous conditions within the launch site. The hazard monitoring system can output a hazard state that is indicative of a zone that is off-limits, the likelihood and/or severity of a potentially hazardous condition, and/or the severity of an existing hazardous condition within the launch site. For example, the hazard state may indicate an ongoing fuel test, a rocket launch, a likelihood and severity of a collision between two vehicles, a vehicle and an individual, a material spill, a malfunction between a material and equipment, and/or other types of potentially hazardous conditions. The hazard monitoring system can be configured to output a tiered determination of the hazard state based on the analysis. The hazard state can be one of a plurality of discrete classifications. Each classification can be associated with a different visual indication.

The hazard monitoring system can additionally generate a graphical interface to communicate the hazard conditions to users in real-time. For example, the hazard monitoring system can output a hazard overlay over the digital twin with hazard zones indicating the hazard conditions.

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” or “another embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

### System Overview

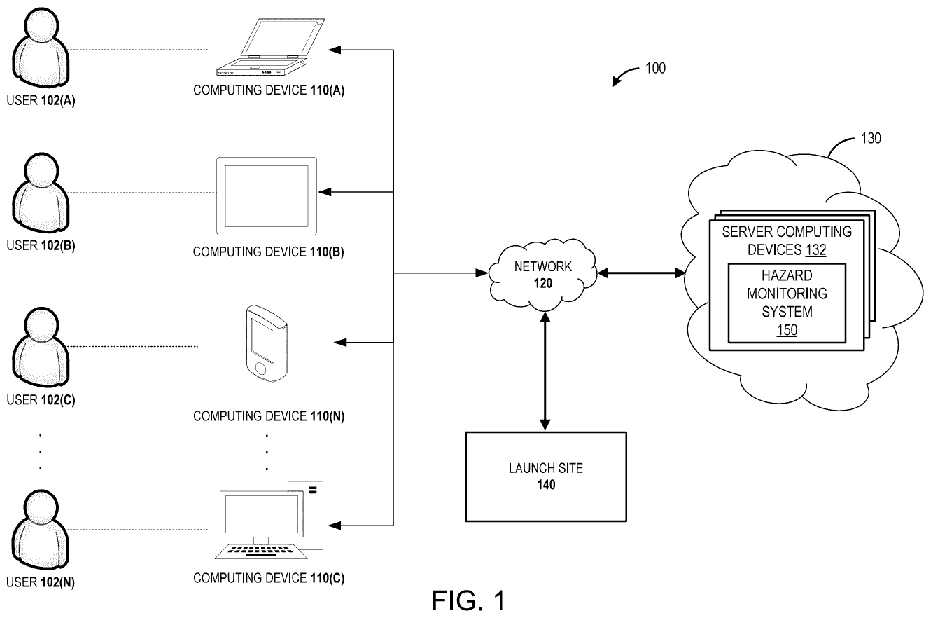

FIG. 1 depicts an example computing system 100 configured to execute embodiments of the hazard monitoring system 150 disclosed herein. The example system 100 includes one or more computing devices, such as computing devices 110, a launch site 140, and a network-based server computing system 130 that includes one or more server computing devices 132. The example system 100 further includes a network 120.

Computing devices 110(A)-(N), generally referred to as computing devices 110, are exemplary hardware devices including computer executable instructions configured for designing, developing, maintaining, monitoring, analyzing, testing, updating, interfacing with, and/or controlling a hazard monitoring system 150—or one or more aspects, features, and/or services thereof—among other things.

Generally, the computing devices 110 can include various forms of processing devices including, but not limited to, a desktop computer, a laptop computer, a tablet computer, a wearable computer, a handheld computer, a personal digital assistant (PDA), a cellular telephone, a network appliance, a smart phone, or an appropriate combination of any two or more of these example data processing devices or other data processing devices. As illustrated in the embodiment of FIG. 1, the computing device 110(A) is a laptop computing device; computing device 110(B) is a tablet computing device; computing device 110(C) is a mobile; and computing device 110(N) is a general computing device.

Users 102(A)-(N), generally referred to as users 102, can include developers, site personnel, and/or automated agents, among other types. In some embodiments, there is a one-to-one correspondence between the users 102 and the computing devices 110. In some embodiments, there is an N-to-one or one-to-N (wherein “N” is an arbitrary real value) correspondence between the users 102 and the computing devices 110. An agent, as known to a person of ordinary skill in the art, can be configured by way of a machine learning model and/or software to automate one or more tasks; such as, for example, updating or modifying the hazard monitoring system 150.

In some embodiments, user 102 provides input to computing devices 110 by way of one or more input devices and/or input methods corresponding and/or associated to computing devices 110, as known to a person of ordinary skill in the art. In some embodiments, computing devices 110 can provide output to users 102 by way of one or more output devices and/or output methods corresponding and/or associated to computing devices 110, as known to a person of ordinary skill in the art.

The network 120 can include a large computer network, such as a local area network (LAN), wide area network (WAN), the Internet, a cellular network, a satellite network, a mesh network, one or more wireless access points, or a combination thereof connecting any number of mobile clients, fixed clients, and servers.

The network-based server computing system 130, which can be generally referred to as server 130, can include a plurality of server computing devices 132. The server computing devices 132 can include a processors and computer-readable memory including computer-executable instructions provided as a non-transitory persistent storage medium, and can represent various forms of server systems including, but not limited to a web server, an application server, a proxy server, a network server, or a server farm.

As discussed in further detail herein, site data (e.g., operational data) can be communicated from the launch site 140 to the server 130 over the network 120. The server 130 can store the site data and/or process the site data to generate and provide auxiliary data. The site data and/or the auxiliary data are communicated over the network 120 to the computing devices 110 for display thereon. User input provided to the computing devices 110 can be communicated to the server 130 over the network 120.

In general, monitoring of launch sites can include monitoring of data generated by sensors and devices at the launch sites, such as, for example, cameras, LiDAR sensors, position sensors, pressure sensors, temperature sensors, flow rate sensors, operational sensors, equipment sensors, and/or other types of sensors or devices for monitoring conditions at the launch site. The data can be used to determine the state of static and dynamic entities at the launch site as discussed in further detail herein.

In some embodiments, a model can include a weather pattern model of the launch site. For example, the model can model temperatures, winds and other appropriate meteorological characteristics that can affect the launch site. In some examples, the weather model can be based on local, regional and/or national weather patterns. In some examples, the weather model can process local, regional, and/or national weather data.

### Hazard Monitoring System

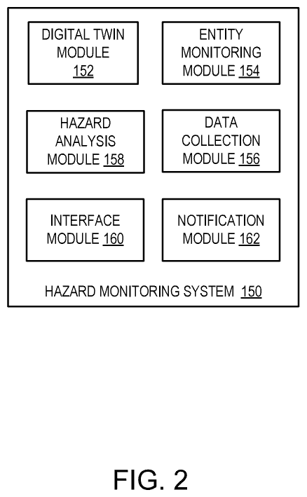

The hazard monitoring system 150 illustrated in more detail in FIG. 2 can be configured to perform various processes and functions associated with the monitoring of launch sites. These processes and functions can be executed by components, which can include digital twin module 152, entity monitoring module 154, data collection module 156, hazard analysis module 158, interface module 160, and notification module 162.

### Digital Twin Module

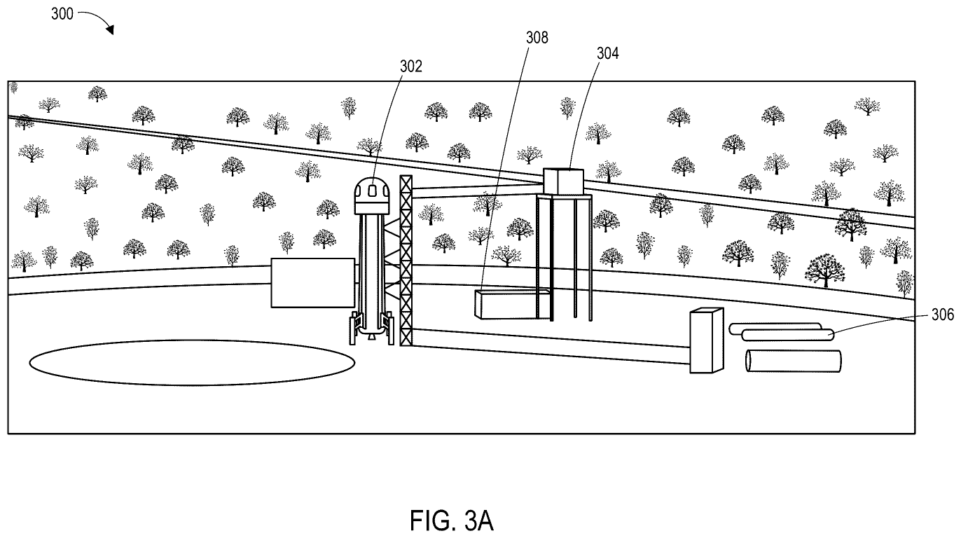

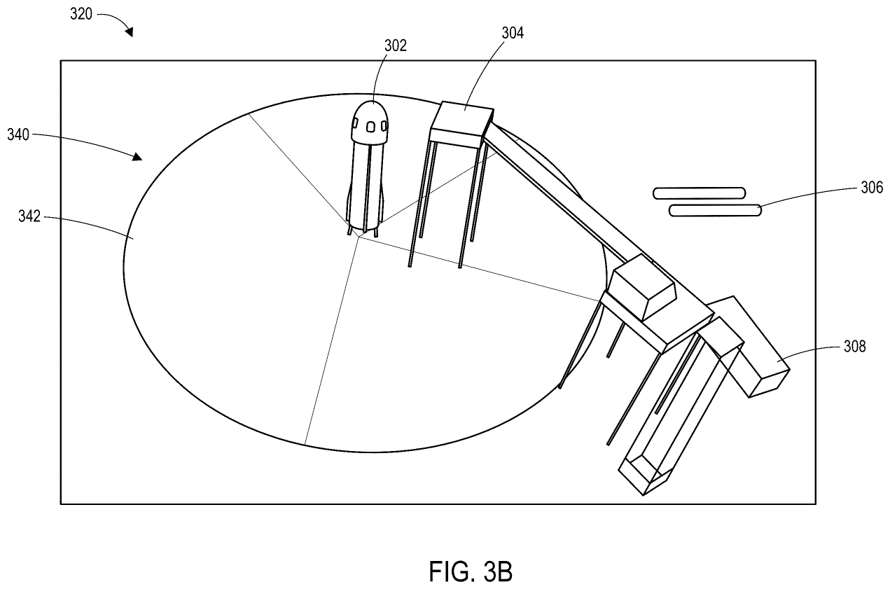

The digital twin module 152 can generate a digital twin of the launch site. The digital twin can be a virtual representation of the launch site, which can be generally referred to as a digital twin. The digital twin module 152 can model the type, size, and location of physical equipment and facilities present at the launch site. FIG. 3B illustrates an example of a digital twin of the real world launch site in FIG. 3A. The digital twin can include topographical features present at the launch site. Example topographical features can include dips, valleys, berms, hills, mountains, and the like. The topographical features may be limited to features within a threshold distance from the launch site, such as within a 2 mile radius.

The digital twin can provide virtual representations of physical systems that are regularly updated with real-world data to mimic the structure, state, and behavior of the systems they represent. To generate a virtual model of the physical environment, virtual entities can be created that are virtual representations of the physical systems, such as, for example, a launch pad, fuel tanks, etc. The virtual entities can be built by using existing and previously built three-dimensional (3D) virtual models, such as, for example, CAD files, Building Information Modeling (BIM) files, or point cloud scans (e.g., photogrammetry, LiDAR, etc.). The digital twin module 152 can use scene composer tools and 3D tools to import virtual assets into the virtual topography and position them to match the physical environment of the launch site.

The digital twin can be modeled to include interfaces to access and use data from a variety of data sources, such as equipment sensors, video feeds, and business applications. The data can be imported into the existing 3D virtual models to create digital twins that functionally mimic of the facilities, processes, and equipment at that launch site. Video and sensor data overlays can be added from connected data sources, which can provide spatially aware visualization of operations at the launch site. The state of the virtual entities can be updated in real-time with data from connected sensors and cameras.

Custom relationships between the entities can be created to accurately represent the real-world deployment of the entities. The entities can be connected to various data stores to form a digital twin graph, which can be a knowledge graph that structures and organizes information about the digital twin for access and understanding. As the digital twin of the physical environment is updated, the digital twin module 152 can create and update the digital twin graph by organizing the relationship information in a graph database, which can be done automatically, semi-automatically, or manually.

The digital twin can be configured with data connectors for interfacing with third-party data sources and services, such as, for example, AWS IoT SiteWise for collecting, organizing, and storing equipment and time-series sensor data; Amazon Kinesis Video Streams for capturing, processing, and storing video data, Amazon Timestream, Snowflake, and Siemens Mindsphere. These data connectors can provide the hazard monitoring system 150 with unified data access to read from and write to the different data stores.

### Data Collection Module

The data collection module 156 can collect data from a variety of data sources, such as equipment sensors, video and audio feeds, and/or other times of data. The data from connected sensors and cameras can be imported into the data collection module 156 and can be updated in real-time. The launch site can include sensors, such as cameras that can configured to collect data about the launch site. The cameras and sensors can be used to generate a state of the environment in real-time. For example, the rocket launch pad, gas storage tanks, and other types of equipment can have specific sensors that provide monitoring data for determining the state of the entities within the launch site at a given time.

In some embodiments, entities present within a launch site may have asset monitoring computing devices, which can monitor dynamic data associated with an entity, such as a vehicle or a person. For example, GPS data can be captured from an asset monitoring device on a vehicle to monitor speed, orientation, and location. In some embodiments, asset monitoring device can be used to dynamically monitor personnel within the launch site. For example, personnel may have a computing device that comprises a sensor for measuring one or more biological parameters that may, for example, be indicative of a physiological condition of the user associated with the tracking computing device. The sensor may be in the form of a wearable separate device, such as a watch, a wristband, a ring, or a heartbeat monitor. A person skilled in the art will understand that any suitable techniques for measuring biological parameters can be used.

The interface for the data collection module 156 can use the site data to continuously update the state of the launch site at any particular point in time. The data collection module 156 may receive the sensor data at different intervals. The type of data received by the data collection module 156 can be based on the type of sensor that generates the data. For example, optical data in the form of still and full motion video can be generated by cameras. The state of the various entities within the launch site can be updated based on the type of sensor information generated. Multiple types of sensor information may be utilized to determine the state of any entity. For example, camera data and an asset monitoring device may be associated with a person at the launch site. The data received by the data collection module 156 can be provided to various modules for analyzing and processing the data.

### Entity Monitoring Module

The entity monitoring module 154 can be configured to determine the state of static and dynamic virtual entities at the launch site. The entity monitoring module 154 can detect and track objects within the launch site in real-time based on the data received from the data collection module 156. The captured data from cameras and sensors can provide location data and operational data associated with the physical entities at the launch site. The entity monitoring module 154 can monitor real-time operations, events, and conditions. The entity monitoring module 154 can be trained based on operation of the launch site based on day-to-day operations, specific events (e.g., a rocket launch) and/or other types of conditions.

The entity monitoring module 154 can track static entities (e.g., gas tanks, structures, etc.) that have been previously generated within the digital twin. The entity monitoring module 154 can automatically detect and track any dynamic entities (e.g., loader vehicles, conveying mechanisms, people, etc.) that move in and through the launch site. The digital twin can be configured to automatically generate and assign identifiers to dynamic entities in real-time based on conditions and entities present at the launch site. For example, the entity monitoring module 154 can be configured to automatically generate and assign an identity to an entity for each person detected at the launch site.

The location data can include three-dimensional location data (e.g., x, y, and z positions) and time data. The data can capture state of the entity in real time and generate real-time updates to the state and/or for location of the entities within the launch site. The operation data can provide an updated state of operation for the virtual entities (e.g., current operating state, pressure, power status, etc.). The updated state and location data can be updated with the digital twin. The entity monitoring module 154 can utilize artificial intelligence models trained on processes and procedures associated with the launch site, proprietary data, and other types of training data to identify and track entities within the launch site.

The entity monitoring module 154 can generate notifications based on the sensor data received from the data collection module 156. For example, optical data can generate notification (e.g., such as a hazard warning) if a person, vehicle, or wild animal enters a restricted area, an object sensor with success and/or failure states, such as a valve, can generate a notification if failure state is detected, environmental sensors (e.g., a pressure sensor, temperature sensors, etc.) can generate a notification if operating conditions are outside acceptable tolerance boundaries (e.g., pressure for a fuel line), functional data associated with operational components (e.g., a panel that is supposed to be active is inactive), temporal data associated with events (e.g., scheduled work or planned change) can generate notifications, and other types of data can be used by the entity monitoring module 154 to generate notifications.

A person skilled in the art will appreciate that various technologies can be used to determine a real-time location of a computing device can be used. For example, the real-time location of a mobile computing device may be determined using GPS, WiFi, radio frequency time of flight or signal strength for example using hazard stateID tags, LiDAR, cameras, nearfield communication, and the like. The selected technology may depend on the application and configuration of the site. For example, at the launch site, the computer system may use camera data and a computing device associated with a vehicle to determine the location, speed, orientation of the vehicle.

### Hazard Analysis Module

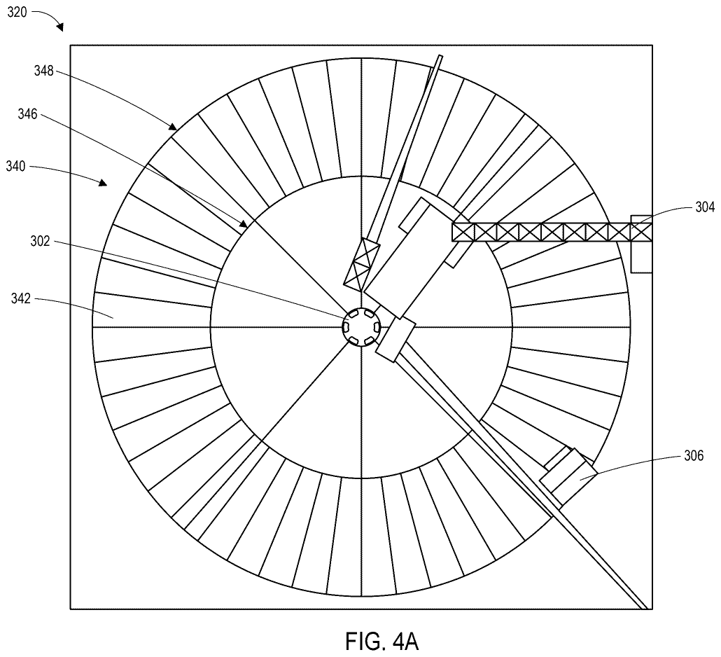

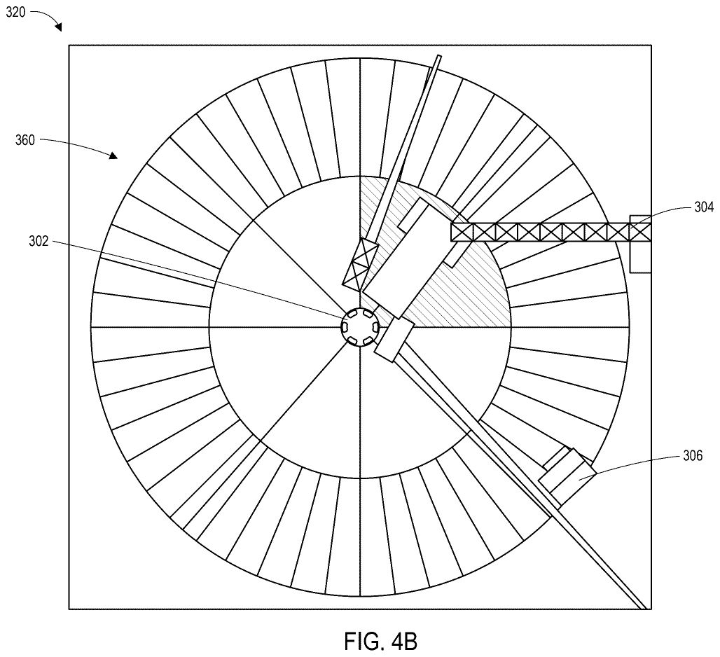

The hazard analysis module 158 can be configured to determine hazardous conditions within the launch site. The hazard analysis module 158 can output a hazard state that is indicative of a zone that is off-limits, the likelihood and/or severity of a potentially hazardous condition, and/or the severity of an existing hazardous condition within the launch site. For example, the hazard state may indicate an ongoing fuel test, a rocket launch, a likelihood and severity of a collision between two vehicles, a vehicle and an individual, a material spill, a malfunction between a material and equipment, and/or other types of potentially hazardous conditions. The hazard analysis module 158 can be configured to perform a hazard analysis to determine a hazard score associated with a hazard zone. The hazard analysis module 158 can be configured to output a tiered determination of the hazard state based on the analysis. The hazard analysis module 158 can additionally determine a graphical indication associated with the hazard state. The hazard state can be one of a plurality of discrete classifications. Each classification can be associated with a different visual indication. For example, the graphical indication can be a red, yellow, or green output based on the risk associated with a specific zone within the launch site. The hazard state can be output so that it is visually represented within a hazard zone (e.g., hazard zone 342 illustrated in FIG. 4A).

The hazard analysis module 158 can be configured to perform the hazardous analysis for each hazard zone independently and for each hazard type. Different analysis models can be used for each analysis of each hazard type. For example, a first model can be used for a collision hazard type and a second model can be used for a gas leak hazard type. The models can be machine learning and AI models developed for the hazard analysis. The hazardous analysis can include determining entities associated with the hazard zone. For example, the hazard analysis module 158 identify the subset of static entities and dynamic entities that are associated with zone. The entities can be within or outside the zone. The hazard analysis module 158 can be configured to determine interactions between the subset of entities based on the hazard type. A hazard score can be determined for the hazard zone based on the determined interactions and additional data associated with the zone and the entities. The hazard state can be determined based on the hazard score.

The hazard analysis module 158 can use the data indicative of the real-time location of the entities and real-time conditions to calculate the hazard state for a plurality of hazard zones within the launch site. The hazard state may be calculated using an algorithm factoring in a distance between entities, a direction and speed of movement, type of entities, operational parameter(s) of the entities, weather information, operational events (e.g., a fueling event). The hazard analysis module 158 may determine static and dynamic weights associated with entities. For example, a static parameter of a large vehicle within a pre-defined area may increase the calculated hazard state due to the potential damage that a large vehicle may cause upon collision. A dynamic parameter assigned to the vehicle may also increase the calculated hazard state if the vehicle is travelling above a predetermined speed. The static parameter of an active worksite in which reactive chemicals, such as fuel, may increase the hazard state due to the severity in case of a collision. The dynamic parameter assigned to a material, such as flow rate or temperature, may also increase the calculated hazard state. The type, number, and weights of parameters used to calculate the hazard state can be determined by user defined and ML-based algorithms. The hazard analysis module 158 may use data obtained from launch site entities (e.g., equipment) to update the hazard state. The obtained data can relate to dynamic parameters that may be obtained in real-time and be indicative of abnormal operation or an altered operation state of a process, such as irregular pressure levels or temperatures. This obtained data can be considered in calculating the hazard state and applying the results to associated areas within the launch site.

The calculated hazard state may be output based on determined processes or events that are scheduled to occur at the launch site, such as a rocket launch, rocket fueling, or other type of event. Each event may have specific conditions and parameters that are associated with the event. These events can cause specific zones of the launch site to have an initial hazard state. In some instances, these events can be activated manually. For each event, there may be a plurality of stages that present different hazard conditions and parameters. During each stage, the hazard analysis module 158 can output the appropriate hazard state associated with the stage and at each zone. The hazard analysis module 158 can utilize parameters associated with each stage to analyze entities within the launch site to update the hazard state in real-time for each zone. For example, the hazard analysis module 158 may determine an initial hazard state for each zone at each stage of a rocket launch. The hazard analysis module 158 can further update the hazard state based on the real-time conditions of the launch site during the stage.

The calculated hazard state may be updated based on the identification of a hazard within an area. The hazard may, for example, relate to a malfunction of equipment, a material spill, a fire, a vehicle accident, or other type of hazard. The calculated hazard state may be used in dynamically generating or revising preventative or mitigative strategies associated with the hazard state, such as safety instrumented systems or fire and gas systems.

Further, the hazard analysis module 158 may use information from any suitable source of database, including but not limited to existing system databases, information systems, asset management platforms, work management tools, camera feeds, aerial imaging, satellite imaging, and other types of data associated with the launch site. The calculated hazard state may then be integrated back into system databases, information systems, asset management platforms, and work management tools. The operational data may be used to train one or more machine learning models associated with calculation of the hazard state.

### Interface Module

The hazard monitoring system 150 further includes an interface module 160 configured to output the digital twin and a plurality of the hazard overlays illustrating the hazard state associated with each hazard zone. For example, the interface module 160 can generate an output for display to a user of computing device 110. Each asset of the launch site may be represented within the digital twin that is updated and displayed with the real-time location and condition(s) of the entities within the launch site. One embodiment of a digital twin of a launch site is illustrated in FIG. 3B based on the real launch site illustrated in FIG. 3A.

After the digital twin has been created, the interface module 160 can provide an interface for building a web application so that users can access and interact with the digital twin in real-time. The interface can provide an interface for visualization to personnel on and off-site. The interface module 160 can provide custom visualization panels, including a 3D scene viewer and dashboard templates, as well as a data-source components for connecting to the digital twin.

Various interfaces can be made available to users of the hazard monitoring system 150, such as administrator interfaces, technician interfaces, operator interfaces, and the like, based on the permissions associated with a user. Information indicative of the plurality of assets may be made available to the user by rendering and outputting the digital twin for display. The output for various interfaces may differ based on the user and the interface that is being viewed by the user. For example, a technician and the administrator may have different information available to them in each interface. The interface module 160 can be configured to make the interfaces available via a network-based interface, such as a web application.

The interface module 160 can generate a rendered map of the digital twin that can display hazard overlay over a digital twin map, such as illustrated in FIG. 4A. Each hazard zone may have a visual indication that is indicative of the determined hazard state. For example, the rendered map may include a green shading of an area with a relatively low hazard state and a red shading is indicative of a relatively high hazard state. A person skilled in the art will appreciate that other methods of displaying the hazard state for each hazard zone can be utilized.

### Notification Module

The hazard monitoring system 150 can include a notification module 162. The hazard analysis module 158 can determine if a hazard state calculated by the hazard analysis module 158 or derived from the information associated with an event within the hazard monitoring system 150 exceeds a predetermined threshold. If the hazard state exceeds a predetermined threshold, the notification module 162 may be configured to automatically communicate a visual notification, an audio notification, and/or an alert to a user. For example, information indicative of a fire may be received at the hazard management system 322, and in response, the risk management system 324 may automatically communicate an alert to the administrator and the plurality of asset computing devices that are currently located within a defined proximity of the area of the elevated hazard state. For example, a real-time alert system can notify users of an event associated with a rocket test that are within a hazard zone defined as off limits during the test, which can help to prevent loss of life and/or further damage. The notification module 162 can provide notice to users based on their location within the launch and alert them of potentially hazardous conditions, such as areas that present safety hazards and are off limits during defined events or based on real-time hazard events.

### Launch Site and Digital Twin

FIG. 3A depicts an image of an example launch site 300. FIG. 3B illustrates a digital twin 320 of the launch site 300. In the depicted example, the launch site 300 includes a rocket 302, a launch tower structure 304, a storage tank system 306, and an on-site control center 308. The launch site 300 can further include personnel, vehicles (e.g., loaders), drones, equipment, and/or other types of entities that assist with operation at the launch site 300.

As described herein, the launch site 300 can include one or more sensors that can be used to detect operating conditions of the launch site 300. The sensors can provide operational conditions associated with the equipment and facilities at the launch site. Each sensor can be responsive to a condition and can generate respective data based thereon. The sensors can include cameras that can provide images of the launch site 300 in real-time. The cameras can be positioned at the launch site to provide visibility of predetermined areas of interest at the launch site. In some embodiments, the launch site can include remote-controlled and/or autonomously controlled drones operating within the vicinity and continuously updating visibility of additional areas of the launch site. The drones can be aerial and/or land-based drones and be configured with various types of sensors, such as cameras, temperature sensors, LiDAR, and/or other types of sensors. The drones can provide mobile coverage of the launch site and may provide overlapping coverage with the existing sensors positioned within the launch site. Vehicles and personnel present at the launch site may have sensors that can be used to determine additional status information associated with the entity.

Sensor data and/or control commands can be provided to/from the launch site through one or more access points, such as the on-site control center 208. Additionally, data can be transmitted between access point(s), the sensor system(s), and/or the communication device. In some examples, the data can be communicated with the network 120 using cellular, satellite, mesh, point-to-point, point-to-multipoint radios, and/or terrestrial or wired communication. In some examples, the signals can be communicated directly to the on-site control center 308 and can be communicated through a network to an off-site control center. For example, the data may be communicated to a server 130. The launch site can include any appropriate number of sensor systems and/or communication devices that facilitate communication of the sensor data.

In some embodiments, the hazard monitoring system 150 can track and monitor launch site personnel. For example, the hazard monitoring system 150 can identify one or more computing devices associated with each of the launch site personnel. The hazard monitoring system 150 can be configured to communicate directly with computing devices associated with the launch site personnel, such as sending and receiving launch site data and/or auxiliary data to/from their computing devices. In some examples, the hazard monitoring system 150 can receive messages from the launch site, the messages can include, for example, site data and hazard notifications. In some examples, the hazard monitoring system 150 can route messages and/or auxiliary data generated by the hazard monitoring system 150 (e.g., analytical data) to the appropriate launch site personnel. Similarly, the hazard monitoring system 150 can route messages (e.g., control messages) from launch site personnel to one or more locations on the launch site.

As described herein, the hazard monitoring system 150 can monitor launch sites, such as launch site 300, and provide updates to the on-site personnel based on actual and potentially hazardous conditions. The hazard monitoring system 150 can then output the conditions to the graphical output of the digital twin. The rendered digital twin 320 can be updated in real-time as the launch site 300 changes. For example, when a vehicle moves, the entity representing the vehicle within the digital twin can be updated to represent the location of the vehicle. In some embodiments, one or more graphical user interfaces (GUIs) can be presented on computing devices, which can depict representations of actual hazardous conditions at the site.

### Hazard Condition Overlay

The hazard monitoring system 150 will be described in further detail with reference to an example of a hazard overlay 340 illustrated in FIG. 4A. The hazard overlay 340 includes a layout of hazard zones 342. Each hazard zone 342 has an independently determinable hazard state. In the illustrated example, the hazard overlay 340 is generated as a circular overlay positioned over a portion of the launch site. The hazard overlay is divided up in a plurality of wedge shaped hazard zones 342 extending radially outward from the rocket 302. An inner section 346 and an outer section 348 are positioned circumferentially about the rocket 302. Each of the hazard zones in first section 346 are the same relative size, and each hazard zone in the second section 348 are the same relative size. The first section 346 and the second section 348 have different shaped and sized hazard zones. Although the hazard overlay 340 is circular and the hazard zones 342 are illustrated as wedges, the hazard overlay 340 and hazard zones 342 can be any shape such as a square, oblong, non-uniform shape, or any other shape. For example, the hazard overlay can be a rectangular grid, and each zone can be square or rectangular shaped. It will be appreciated that the shapes do not have to be uniform and there may be any number of zones.

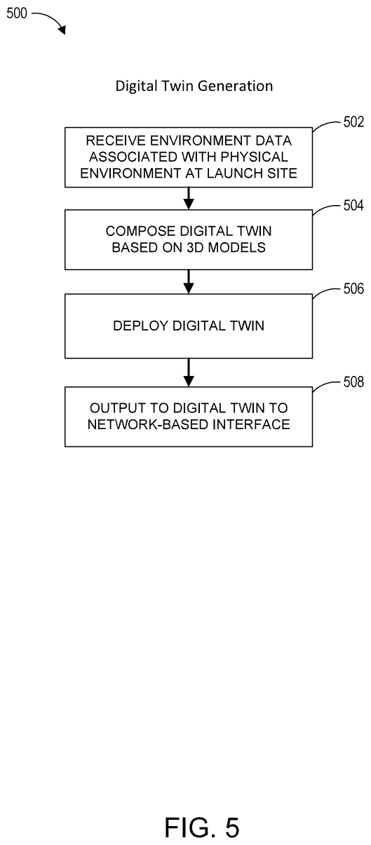

Each hazard overlay and corresponding hazard zones can be associated with a specific hazard type. An example hazardous event illustrated in FIG. 5 can be a rocket launch. It is appreciated that embodiments of the present disclosure are applicable to other appropriate hazardous conditions. During a rocket launch event, the launch site can include zones within a proximity to the rocket that are off limits due to high risk. Leading up to the rocket launch event, there can be a number of stages that have varying levels of risk at different hazard zones within the launch site.

Different types of hazards can have different hazard overlays and different hazard zones. Each hazard type can have different properties and constraints. For example, in the illustrated example, the hazard overlay radiates out from the rocket. In another hazard type, the hazard overlay could radiate out from another point of origin, such as the gas tank system (for example, if there was a gas leak). The hazard overlay can be sized to extend from a point of origin for a defined distance based on the properties and constraints associated with the hazard type. The terrain can influence the hazard overlay and the hazard zone. For example, the segments may be shaped to conform to various terrain boundaries. In some instances, there may be no point of origin, and the hazard overlay is a grid that generally extends to cover the launch site.

The hazard monitoring system 150 can be configured to generate an interface that allows the user to view each hazard type. The hazard monitoring system 150 can be configured to allow the user to cycle through each hazard type. The hazard types may be condition-based hazards (such as a fire, a gas leak, an accident, or other hazardous condition) or an event-based hazards (such as rocket refueling, rocket launch, or other defined event). For the condition-based hazards, the hazard monitoring system 150 can dynamically determine the output of the hazard overlay based on existing conditions (for example, the current location of a fire). For the event-based hazards, the hazard monitoring system 150 can have defined parameters for output of the hazard overlay based on conditions of the event. For example, during a fueling event, specific areas of the hazard overlay can have defined hazard levels. The event-based hazard overlays can be updated based on existing conditions in combination with event parameters.

In some instances, each hazard type will use the same hazard overlay. In some instances, the hazard overlay can be different. For example, for a hazard type associated with driving on roads by vehicles, the hazard overlay could be shaped to cover the roads and/or other locations where vehicles and/or personnel could travel. In another example, the hazard type could be a gas leak from the storage tank system 306. The hazard overlay could be configured to be centered about the storage tank system 306.

The interfaces for each hazard type can provide different information to the user. For example, in a first hazard type, the hazard monitoring system 150 can display the hazard zone associated with a hazard event. In a second hazard type, the hazard monitoring system 150 can display the location of entities positioned within the hazard zones from the first hazard type. In some examples, each hazard zone can have a respective color and/or pattern that is distinct from colors and/or patterns of other indicators that indicate the type of entity within a hazard zone. For example, a hazard zone may have a first color to indicate that a person is within a hazard zone and a second color to indicate that a vehicle is within a hazard zone.

The hazard monitoring system 150 can update the hazard state of the hazard zones based on defined events, such as a rocket launch and/or based dynamic events, such as a fuel spill or a vehicle collision. Based on the analysis of the hazardous event data, the hazard monitoring system 150 can generate the graphical representations of the hazardous condition at the launch site. Each hazard zone can provide a condition indicator based on the determined hazard state of the hazard zone. The graphical representations can provide an easily identifiable indication of the hazard state associated with the hazard zone. Unsafe areas can use different shades of red instead of grey whereas safe areas can use shades of green. The hazard monitoring system 150 can limit the number of visual indications, for example, red areas, green areas, and undefined areas.

In some instances, different visual characteristics can be provided based on hazard state. Example visual characteristics can include color, shape, and/or pattern. The hazard overlay can be a colorization of the surface map such that the user can see ground detail, such as illustrated in FIG. 3B. For example, a surface map can be a colorized or grey scale rendering of the surface topology or surface features.

In some embodiments, the hazard monitoring system 150 can be configured to provide an indicator of the user position within the launch site and can be updated as the user moves within the launch site. The hazard monitoring system 150 can be configured to automatically open the hazard map interface to a hazard type that has the highest risk based on the location of the user. For example, if the user is in a high danger zone, the hazard map may open to the hazard type where the hazard level is greatest.

The hazard map can be generated as a two dimensional or three dimensional map and can include surface detail, such as elevation changes. Similarly, the hazard map can be displayed in two or three dimensions to a user. The hazard mapping could be displayed in 3D, such as with a top down view (e.g., FIG. 4A) or an isometric view (e.g., FIG. 3B).

The graphical representation of the hazardous condition enables users to remotely evaluate the launch site, e.g., before actually approaching the launch site. For example, a user can be tasked with rectifying a hazardous condition, by visiting the launch site to implement remedial measures. In some examples, the user can view a graphical representation of the launch site before approaching the launch site. In this manner, the user can determine a direction for approaching the launch site, and/or locations within the launch site to avoid.

FIG. 4B depicts the graphical representation 360 corresponding to a hazardous condition that is present at the launch site. In this example, the hazardous condition is an event-based condition that illustrates a phase of a rocket launch. In some embodiments, the hazardous condition can be based on a pre-determined event, such as a rocket launch. In such an event, the hazard monitoring system 150 may have predetermined hazard states for each hazard segment. The predetermined hazard states can indicate stages of the launch sequence. The hazard state illustrated in FIG. 4B illustrates a fueling event where the hydrogen line providing fuel to the launch vehicle is active. In later stages of the launch sequence, an area around the rocket may be designated as no entry zones. The hazard monitoring system 150 can further process the site data to determine whether additional hazardous conditions exist. The hazard monitoring system 150 can update the hazard zones based on the analysis. For example, during the rocket launch event, the hazard monitoring system 150 can determine that personnel, vehicles, drones, and/or other entities are in unauthorized zones of the launch site. The hazard monitoring system 150 can be configured to provide a notification to users, such as administrators, to alert them in order to remedy the situation. In some embodiments, the hazard monitoring system 150 may be able to identify the unauthorized entities and communicate with them directly to indicate that they are in an unsafe location. In some instances, the hazard monitoring system 150 may provide directions for moving outside of the hazard zone to an acceptable zone. For example, the user may receive directions to move 100 meters south of their current position to a location that is outside the risk zone and into a position of safety.

### Process for Generating a Digital Twin

FIG. 5 illustrates an embodiment of a flowchart for a process 500 for generating a digital twin within a network-based computing environment. The process 500 can be implemented by a computing system that can receive, process, and model a three dimensional environment in a network-based computing environment. For example, the process 500, in whole or in part, can be implemented by a hazard monitoring system 150, digital twin module 152, or other computing system. Further, although embodiments of the process 500 may be performed with respect to various computing environments, to simplify discussion, the process 500 will be described with respect to the hazard monitoring system 150.

At block 502, the hazard monitoring system 150 receives environment data associated with physical environment of the launch site. The hazard monitoring system 150 can be configured to generate 3D virtual representations of the terrain and physical systems, such as, for example, a launch pad, fuel tanks, etc. The 3D models can be built by using existing and previously built 3D visual models, such as, for example, CAD files, Building Information Modeling (BIM) files, or point cloud scans (e.g., photogrammetry, LiDAR, etc.). The hazard monitoring system 150 can build 3D models associated with each of the assets within the launch site. Additionally, 3D models can be used to represent each of the different entities that will be present within the launch site such as vehicles, workers, facilities, etc. The digital twin can include topographical features of the terrain at the launch site. Example topographical features can include dips, valleys, berms, hills, mountains, and the like.

At block 504, the hazard monitoring system 150 can compose a digital twin of the launch site using the 3D models. The digital twin includes virtual representations of the physical systems that are regularly updated with real-world data to mimic the structure, state, and behavior of the systems they represent. The hazard monitoring system 150 can use a scene composer tool and 3D tools to import virtual assets into a scene and position them to match the physical environment of the launch site. Custom relationships between the virtual entities can be created to accurately represent the real-world deployment of the physical entities. The entities can be connected to form a knowledge graph, which can structure and organize information about the digital twin for access and understanding. Each virtual entity can be registered and assigned identities. The hazard monitoring system 150 can establish communication protocols (e.g., MQTT, HTTP, WebSockets, etc.) for communicating with the physical entities. When the digital twin of the physical environment is updated, the digital twin graph can be updated, which can be done automatically, semi-automatically, or manually.

Video and sensor data overlays can be added from connected data sources (e.g., internet-of-things (IoT) sensors, enterprise databases, external APIs), insights from connected machine learning (ML) and simulation services, and maintenance records and operational documents, which can provide a spatially aware visualization of operations at the launch site.

At block 506, the hazard monitoring system 150 can deploy the digital twin. Digital twin models can be virtual representations of physical systems that are regularly updated with real-world data to mimic the structure, state, and behavior of the systems they represent. The digital twin model can include interfaces to easily access and use data from a variety of data sources, such as equipment sensors, video feeds, and business applications. The hazard monitoring system 150 can visualize insights and generate predictions based on the data, and provide notifications, such as raise alarms, to identify when data or predictions deviate from expectations. The digital twin can be integrated into web-based applications that allow personnel to monitor and improve operations.

The digital twin module can be configured with data connectors for interfacing with third-party data sources and services, such as, for example, AWS IoT SiteWise for collecting, organizing, and storing equipment and time-series sensor data; Amazon Kinesis Video Streams for capturing, processing, and storing video data, Amazon Timestream, Snowflake, and Siemens Mindsphere. These data connectors can allow the hazard monitoring system 150 to use the digital twin module for a unified data access API to read from and write to the different data stores without needing to query each data source using their own individual API. The hazard monitoring system 150 can continuously refine the digital twin with feedback loops and ML improvements.

At block 508, the hazard monitoring system 150 outputs the digital twin to a network-based interface for real-time visualization. The interface module 160 may further be configured to generate an output to be communicated to computing devices 110 via a worker interface. The output for various interfaces may differ based on the user and the interface that is being viewed by the user. For example, a technician and the administrator may have different information available to them in each interface.

### Real-Time Monitoring Process

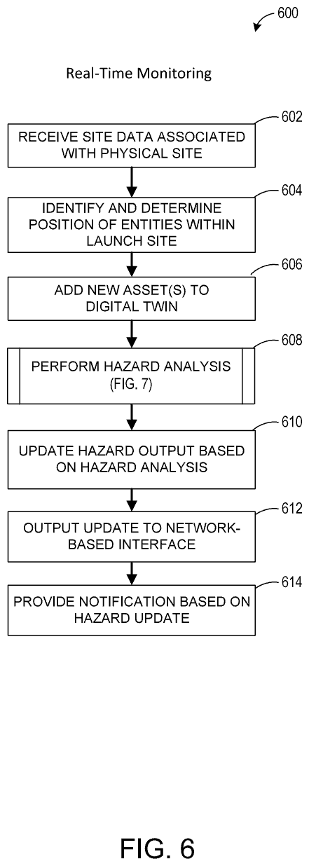

FIG. 6 illustrates an embodiment of a flowchart for a process 600 for monitoring a launch site for hazardous conditions. The process 600 can be implemented by a computing system that can receive and process data associated with a launch site in a network-based computing environment. For example, the process 600, in whole or in part, can be implemented by a hazard monitoring system 150 or other computing system. Further, although embodiments of the process 600 may be performed with respect to various computing environments, to simplify discussion, the process 600 will be described with respect to the hazard monitoring system 150.

At block 602, the hazard monitoring system 150 receives site data associated with the launch site. The hazard monitoring system 150 can collect data from a variety of data sources, such as equipment sensors, video and audio feeds, and/or other times of data. The data from connected sensors and cameras can be provided to the hazard monitoring system 150 and can be updated in real-time. The launch site can include sensors, such as cameras that can be configured to collect data about the launch site. The cameras and sensors can be used to generate a state of the environment in real-time. For example, the rocket, the gas storage tanks, and other types of equipment can have specific sensors that provide monitoring data for determining the state of the entities within the launch site at a given time. In some embodiments, the location data for entities can be received from tracking computing devices including a locating component (e.g., GPS) within the computing device. Each computing device can be associated with an entity, such as a vehicle or personnel.

The site data can be communicated from each data source (e.g., sensors, computing devices, etc.) to the hazard monitoring system 150 through a communications network using a compatible network interface. The data may be communicated automatically, for example periodically or continuously. Each data source may communicate at different intervals.

At block 604 the hazard monitoring system 150 identifies and determines positions of entities within launch site. The hazard monitoring system 150 can use the site data to determine the identities of the entities within the launch site. For example, the hazard monitoring system 150 can use image recognition and/or ML algorithms to identify entities. The hazard monitoring system 150 can also determine the real-time location of the plurality of entities. The hazard monitoring system 150 may use the site data, such as camera feeds or satellite imaging to determine the real-time location of the plurality of entities. In some embodiments, the hazard monitoring system 150 may obtain the real-time location of an entity based on a tracking computing device associated with the entity. For example, the real-time location of the entity may be stored in a location database based on the output from the tracking computing device.

The hazard monitoring system 150 can continuously calculate the real-time location of the entities within the launch site. The hazard monitoring system 150 can map each of the entities to a hazard segment within the launch site. The hazard monitoring system 150 can use the site data to continuously update the state of the launch site at any particular point in time. The hazard monitoring system 150 may receive the sensor data at different intervals. The information can be updated based on the sensor information that can then be provided to various modules for analyzing and processing the data at the launch site.

At block 606, the hazard monitoring system 150 may identify a new entity within the launch site. The hazard monitoring system 150 may a identify a new entity that is not associated with an identifier. For example, an entity may move into the launch site, such as a vehicle or a person. The hazard monitoring system 150 may automatically generate an identifier associated with the new entity. The hazard monitoring system 150 may also categorize the entity based on site data. For example, the hazard monitoring system 150 may utilize ML algorithms to identify the type of entity, such as a truck, a loader vehicle, a person, or other category of entity.

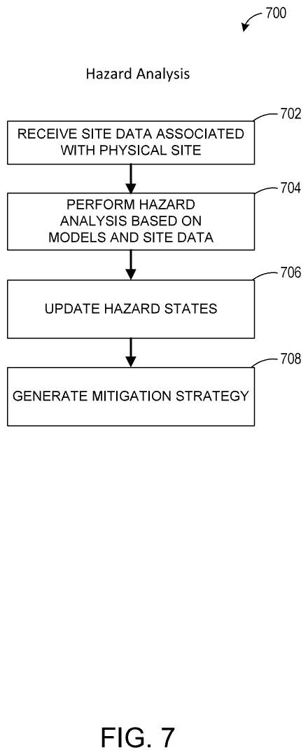

At block 608, the hazard monitoring system 150 can perform the hazard analysis process. The hazard monitoring system 150 can calculate a hazard state indicative of a likelihood and/or severity of an undesired interaction between at least two assets within a hazard segment. For example, the hazard state can be calculated using the information indicative of the real-time location of each entity. For example, the hazard state may indicate a likelihood and severity of a collision between two vehicles, a vehicle and an individual, a material spill and an individual, a malfunction between a material and equipment or two materials. The hazard analysis process is further described with respect to FIG. 7.

At block 610, the hazard monitoring system 150 can update a hazard detection output based on the hazard analysis. The hazard analysis can be configured to output a tiered determination of risk based on the analysis. The hazardous output data can be processed to generate graphical representations. For example, the output can be a red, yellow, or green based on the hazard state associated with a specific hazard zone. Additionally, the output data can include data associated with the type of hazard, such as event type, time, location and supplemental data. In this manner particular locations within the launch site can be associated with the hazardous event. In some examples, output data can be provided as a tuple of values. The location data can include coordinate data, e.g., x-y coordinates in two-dimensional space, x-y-z coordinates in three-dimensional space. In some examples, a location can include sensor readings from one or more sensors associated with the location(s) at different times.

At block 612, the hazard monitoring system 150 may output an update to one of more hazard state in the hazard overlay over a network-based interface. The output can be an update to visual output associated with a hazard zone based on a change in the hazard state due to the determination of a hazardous event. For example, the output can display a red, yellow, or green output based on the hazard state associated with a specific hazard zone. The hazard monitoring system 150 can generate an output that is communicated to computing devices via a network-based interface. For example, the output may be communicated to a user computing device in response to a request. The output for various interfaces may differ based on the user and the interface that is being viewed by the user.

At block 614, the hazard analysis module 158 may provide a notification based on the hazard update. The hazard monitoring system 150 can determine if a hazard state calculated by the hazard analysis module 158 or derived from the information associated with an event within the hazard monitoring system 150 exceeds a predetermined threshold. If the hazard state exceeds a predetermined threshold, the risk management system 324 may automatically communicate a visual and/or audio notification or an alert to a user. For example, information indicative of a fire may be received at the hazard management system 322, and in response, the risk management system 324 may automatically communicate an alert to the administrator and the plurality of asset computing devices that are currently located within a defined proximity of the area of the elevated hazard state. If a calculated hazard state exceeds a predetermined threshold. If the calculated hazard state exceeds the predetermined threshold, the processor may communicate an alert to at least one of the plurality of computing devices.

### Hazard Analysis Process

FIG. 7 illustrates an embodiment of a flowchart for a process 700 for performing a hazard analysis at a launch site. The process 700 can be implemented by a computing system that can receive and process data associated with a launch site in a network-based computing environment. For example, the process 700, in whole or in part, can be implemented by a hazard monitoring system 150 or other computing system. Further, although embodiments of the process 700 may be performed with respect to various computing environments, to simplify discussion, the process 700 will be described with respect to the hazard monitoring system 150.

At block 702, the hazard monitoring system 150 receives site data associated with the launch site. The hazard monitoring system 150 can collect data from a variety of data sources, such as equipment sensors, video and audio feeds, and/or other times of data. The data from connected sensors and cameras can be provided to the hazard monitoring system 150 and can be updated in real-time.

At block 704, the hazard monitoring system 150 can determine whether potentially hazardous conditions exist within the launch site. The data and the one or more models can be processed to determine an extent of the location and/or severity of the hazardous conditions. The hazard analysis module 158 can output a hazard state that is indicative of a likelihood and/or severity of an undesired interaction between at least two assets within an area within the launch site. For example, the hazard state may indicate a likelihood and severity of a collision between two vehicles, a vehicle and an individual, a material spill and an individual, a malfunction between a material and equipment or two materials. The hazard state can be configured to output a tiered determination of risk based on the analysis.

The hazard monitoring system 150 can be configured to perform the hazardous analysis for each hazard zone independently and for each hazard type. Different analysis models can be used for each analysis of each hazard type. For example, a first model can be used for a collision hazard type and a second model can be used for a gas leak hazard type. The models can be machine learning and AI models developed for the hazard analysis. The hazardous analysis can include determining entities associated with the hazard zone. For example, the hazard analysis module 158 identify the subset of static entities and dynamic entities that are associated with zone. The entities can be within or outside the zone. The hazard analysis module 158 can be configured to determine interactions between the subset of entities based on the hazard type. A hazard score can be determined for the hazard zone based on the determined interactions and additional data associated with the zone and the entities. The hazard state can be determined based on the hazard score.

The hazard analysis module 158 can use the data indicative of the real-time location of the entities and real-time conditions to calculate the hazard state for an area within the launch site. The hazard state may be calculated using an algorithm factoring in a distance between assets, a direction and speed of movement, type of assets, operational parameter of the asset and weather information captured by a weather sensor.

The calculated hazard state may be used in risk analysis based on determined processes or events that are scheduled to occur at the launch site, such as a rocket launch, rocket fueling, or other type of event. Each event may have specific conditions and parameters that are associated with the event. The calculated hazard state may further increase based on the identification of a hazard within an area. The hazard may, for example, relate to a malfunction of equipment, a material spill, a fire, a vehicle accident, or other type of hazard.

Considering an example of a dynamic hazardous condition of fuel leak in the gas storage system, the hazard analysis module 158 can analyze gas composition sensor data and camera data (e.g., a visible leakage of fuel) to determine whether a hazardous condition exists. For example, the sensors can be responsive to the presence of gas or a drop in pressure. The sensors can generate a signal that indicates a condition that is out of the ordinary, such as the presence of a gas. In some examples, the signal can indicate a higher concentration of the gas, e.g., in PPM.

In some embodiments, the hazard analysis module 158 can use one or more models for each type of hazardous condition. For example, the one or more models can be stored in computer-readable memory. In some examples, the hazard analysis module 158 can include properties associated with hazardous materials that can be present at the launch site. For example, the properties can be stored in computer-readable memory. Data associated with the launch site can be received by the hazard analysis module 158. For example, data, e.g., signals, generated at the launch site can be provided to the hazard analysis module 158 through one or more networks. In some examples, one or more external sources can provide data associated with the launch site. For example, meteorological data can be provided from one or more weather services, e.g., local, regional and/or national weather services. In some examples, the weather data can be meteorological data provided directly from the launch site, e.g., from a weather station located at the launch site (monitoring wind speed/direction, temperature, humidity, and/or barometric pressure).

The hazard analysis module 158 can generate hazardous events based on the processing of the data. The hazard analysis module 158 processes the one or more models and the data using an engine to provide output data indicative of the hazardous event. Due to large amounts of data, it can be difficult for a user to identify events. When the data indicates that an anomalous or hazardous event has occurred, the hazardous event can be generated. In some examples, the hazard analysis module 158 processes the one or more models and the data in response to a determination that a hazardous condition is present at the launch site. For example, if a gas sensor indicates presence of a gas at a concentration that exceeds a threshold concentration, it can be determined that a hazardous condition is present. Consequently, the hazard analysis module 158 can retrieve the one or more models and the data, e.g., from memory, and process the one or more models and the data to provide output data based on the type of hazardous event. In some examples, the output data indicates locations and concentrations of hazardous gas at the launch site.

At block 706, the hazard monitoring system 150 may output an update to one of more hazard states based on the analysis. The output can update a hazard state associated with a hazard zone. The hazard monitoring system 150 can generate a hazard event out output that is communicated to computing devices via a network-based interface.

The hazard analysis output can be processed to generate graphical representations, discussed in further detail herein. For example, the output can be to display a red, yellow, or green graphical indication based on the hazard state associated with a specific hazard zone. Additionally, the output data can include additional hazard data, such as, for example, the type of hazard, hazard event type, time, location and supplemental data. In this manner, particular locations within the launch site can be associated with the hazardous event. The location data can include coordinate data, e.g., x-y coordinates in two-dimensional space, x-y-z coordinates in three-dimensional space. In some examples, a location can include sensor readings from one or more sensors associated with the location(s) at different times.

In some embodiments, the output data can include actual values from the sensors associated with the hazardous event. For example, pressure data can be provided as actually measured value at the respective time based on a signal from a sensor. In some embodiments, data associated with the hazardous event can include estimated values based on analysis of the hazardous event. In some examples, estimated values are provided based on one or more other values (actual and/or estimated), data, e.g., gas properties, weather, and one or more models.

For example, a first value for a temperature reading can be provided as an actual value at a first location, e.g., the location of a temperature sensor. A second value for temperature can be provided as an estimated value at a second location, e.g., a location adjacent to the first location. In some examples, the second value can be provided based on the first value, one or more previous values associated with the second location, one or more previous values associated with the first location, one or more event models, and one or more models, e.g., fluid flow model, weather model, model of the launch site, weather data, and/or other types of data.

At block 708, the hazard monitoring system 150 may output a mitigation strategy based on the calculated hazard state and/or determined events. The calculated hazard state may be used in dynamically generating or revising preventative or mitigative strategies associated with the hazard state, such as safety instrumented systems or fire and gas systems.

### Overview of Computing Device

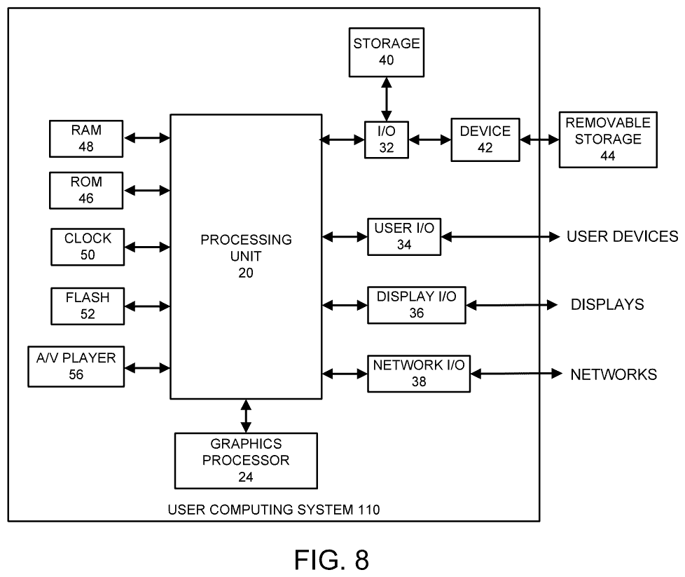

FIG. 8 illustrates an embodiment of computing device, such as computing devices 110 and server computing devices 132, according to the present disclosure. Other variations of the computing device 10 may be substituted for the examples explicitly presented herein, such as removing or adding components to the computing device 10. The computing device 10 may include a smart phone, a tablet, a personal computer, a laptop, a smart television, a car console display, a server, and the like. As shown, the computing device 10 includes a processing unit 20 that interacts with other components of the computing device 10 and also external components to computing device 10. A media reader 22 is included that communicates with media 12. One or more of the computing devices may be used to implement one or more of the systems disclosed herein.

Computing device 10 may include a separate graphics processor 24. In some cases, the graphics processor 24 may be built into the processing unit 20. In some such cases, the graphics processor 24 may share Random Access Memory (RAM) with the processing unit 20. Alternatively, or in addition, the computing device 10 may include a discrete graphics processor 24 that is separate from the processing unit 20. In some such cases, the graphics processor 24 may have separate RAM from the processing unit 20. Computing device 10 might be a general-purpose laptop or desktop computer, a smart phone, a tablet, or other suitable computing system.

Computing device 10 also includes various components for enabling input/output, such as an I/O 32, a user I/O 34, a display I/O 36, and a network I/O 38. I/O 32 interacts with storage element 40 and, through a device 42, removable storage media 44 in order to provide storage for computing device 10. Processing unit 20 can communicate through I/O 32 to store data, such as state data and any shared data files. In addition to storage 40 and removable storage media 44, computing device 10 is also shown including ROM (Read-Only Memory) 46 and RAM 48. RAM 48 may be used for data that is accessed frequently.

User I/O 34 is used to send and receive commands between processing unit 20 and user input devices. In some embodiments, the user I/O can include a touchscreen inputs. The touchscreen can be capacitive touchscreen, a resistive touchscreen, or other type of touchscreen technology that is configured to receive user input through tactile inputs from the user. Display I/O 36 provides input/output functions that are used to display images. Network I/O 38 is used for input/output functions for a network. Network I/O 38 may be used during execution of an application.

Display output signals produced by display I/O 36 comprising signals for displaying visual content produced by computing device 10 on a display device, such as graphics, user interfaces, video, and/or other visual content. Computing device 10 may comprise one or more integrated displays configured to receive display output signals produced by display I/O 36. According to some embodiments, display output signals produced by display I/O 36 may also be output to one or more display devices external to computing device 10, such a display 16.

The computing device 10 can also include other hardware features, such as a clock 50, flash memory 52, and other components. An audio/video player 56 might also be used to play a video sequence, such as a movie. It should be understood that other components may be provided in computing device 10 and that a person skilled in the art will appreciate other variations of computing device 10.

Program code can be stored in ROM 46, RAM 48 or storage 40 (which might comprise hard disk, other magnetic storage, optical storage, other non-volatile storage or a combination or variation of these). Part of the program code can be stored in ROM that is programmable (ROM, PROM, EPROM, EEPROM, and so forth), part of the program code can be stored in storage 40, and/or on removable media (which can be a CD-ROM, cartridge, memory chip or the like, or obtained over a network or other electronic channel as needed). In general, program code can be found embodied in a tangible non-transitory signal-bearing medium.

Random access memory (RAM) 48 (and possibly other storage) is usable to store variables and other application and processor data as needed. RAM is used and holds data that is generated during the execution of an application and portions thereof might also be reserved for frame buffers, application state information, and/or other data needed or usable for interpreting user input and generating display outputs. Generally, RAM 48 is volatile storage and data stored within RAM 48 may be lost when the computing device 10 is turned off or loses power.

Data from storage 40, ROM 46, servers accessed via a network (not shown), or removable storage media 44 may be read and loaded into RAM 48. Although data is described as being found in RAM 48, it will be understood that data does not have to be stored in RAM 48 and may be stored in other memory accessible to processing unit 20 or distributed among several media, such as media 12 and storage 40.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include these features, elements and/or states.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

While the above detailed description may have shown, described, and pointed out novel features as applied to various embodiments, it may be understood that various omissions, substitutions, and/or changes in the form and details of any particular embodiment may be made without departing from the spirit of the disclosure. As may be recognized, certain embodiments may be embodied within a form that does not provide all of the features and benefits set forth herein, as some features may be used or practiced separately from others.

Additionally, features described in connection with one embodiment can be incorporated into another of the disclosed embodiments, even if not expressly discussed herein, and embodiments having the combination of features still fall within the scope of the disclosure. For example, features described above in connection with one embodiment can be used with a different embodiment described herein and the combination still fall within the scope of the disclosure.

It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other embodiments. Those skilled in the art will appreciate that in some embodiments, the actual steps taken in the processes illustrated and/or disclosed may differ from those shown in the figures. Depending on the embodiment, certain of the steps described above may be removed, others may be added.

Furthermore, the features and attributes of the specific embodiments disclosed above may be combined in different ways to form additional embodiments, all of which fall within the scope of the present disclosure. Also, the separation of various system components in the embodiments described above should not be understood as requiring such separation in all embodiments, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Unless the context clearly requires otherwise, throughout the description and the claims, the words “comprise,” “comprising,” and the like, are to be construed in an inclusive sense as opposed to an exclusive or exhaustive sense, that is to say, in the sense of “including, but not limited to.”

Reference to any prior art in this description is not, and should not be taken as, an acknowledgement or any form of suggestion that that prior art forms part of the common general knowledge in the field of endeavor in any country in the world.

The invention may also be said broadly to consist in the parts, elements and features referred to or indicated in the description of the application, individually or collectively, in any or all combinations of two or more of said parts, elements or features.

Where, in the foregoing description, reference has been made to integers or components having known equivalents thereof, those integers are herein incorporated as if individually set forth. In addition, where the term “substantially” or any of its variants have been used as a word of approximation adjacent to a numerical value or range, it is intended to provide sufficient flexibility in the adjacent numerical value or range that encompasses standard manufacturing tolerances and/or rounding to the next significant figure, whichever is greater.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be noted that various changes and modifications to the presently preferred embodiments described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. Accordingly, the scope of the present invention is intended to be defined only by the claims.

What is claimed is:

1. A system for hazard analysis at a launch site, the system comprising:
a non-transitory computer storage medium configured to at least store computer-executable instructions; and
one or more hardware processors in communication with the non-transitory computer storage medium, the computer-executable instructions, when executed by the one or more hardware processors, cause the one or more hardware processors to:
receive site data associated with a launch site, wherein the site data comprises location data and operational data associated with a plurality of static physical entities and a plurality of dynamic physical entities at the launch site;
access a first hazard overlay associated with the launch site, wherein the first hazard overlay divides at least a portion of the launch site into a plurality of hazard zones, wherein the first hazard overlay is associated with a first hazard type, wherein each hazard zone is associated with a hazard state;
determine a hazard state for each hazard zone, wherein the determination of the hazard state comprises:
determine a first subset of entities associated with the hazard zone, wherein the first subset of entities comprises at least one of a static virtual entity of the plurality of static physical entities or a dynamic virtual entity of the plurality of dynamic physical entities;
determine interactions between the first subset of entities based at least in part on the first hazard type;
determine a hazard score for the hazard zone based at least in part on the determined interactions between the first subset of entities; and
output the hazard state based at least in part on the hazard score; and
output instructions to display visual indications associated with the determined hazard states.

2. The system of claim 1, wherein the hazard score further comprises hazard output data associated with the determination of the hazard score.

3. The system of claim 1, wherein the hazard state is one of a plurality of discrete classifications.

4. The system of claim 3, wherein each of the plurality of discrete classifications is associated with a different visual indication.

5. The system of claim 1, wherein the site data further comprises auxiliary data, and wherein the determination of the hazard score is further based at least in part on the auxiliary data, wherein the auxiliary data comprises at least one of hazardous event data or weather data.

6. The system of claim 1, wherein the first subset of entities comprise static entities and dynamic entities that are located outside of the hazard zone.

7. The system of claim 1, wherein the hazard state for each hazard zone is determined independently.

8. The system of claim 1, wherein the determination of a hazard state for each hazard zone is determined using a machine learning model associated with the first hazard type.

9. The system of claim 8, wherein the computer-executable instructions, when executed, further cause the one or more hardware processors to:
access a second hazard overlay associated with the launch site, wherein the second hazard overlay divides at least a portion of the launch site into a plurality of hazard zones, wherein the second hazard overlay is associated with a second hazard type,
wherein the determination of a hazard state for each hazard zone associated with the second overlay is determined using a machine learning model associated with the second hazard type.

10. The system of claim 1, wherein the site data is received in real-time from the launch site, and the determination of a hazard state for each hazard zone is determined in real-time.

11. A method for hazard analysis at a launch site, the method comprising:
receiving site data associated with a launch site, wherein the site data comprises location data and operational data associated with a plurality of static physical entities and a plurality of dynamic physical entities at the launch site;
accessing a first hazard overlay associated with the launch site, wherein the first hazard overlay divides at least a portion of the launch site into a plurality of hazard zones, wherein the first hazard overlay is associated with a first hazard type, wherein each hazard zone is associated with a hazard state;
determining a hazard state for each hazard zone, wherein the determination of the hazard state comprises:
determining a first subset of entities associated with the hazard zone, wherein the first subset of entities comprises at least one of a static virtual entity of the plurality of static physical entities or a dynamic virtual entity of the plurality of dynamic physical entities;
determining interactions between the first subset of entities based at least in part on the first hazard type;
determining a hazard score for the hazard zone based at least in part on the determined interactions between the first subset of entities; and
outputting the hazard state based at least in part on the hazard score; and
outputting instructions to display visual indications associated with the determined hazard states.

12. The method of claim 11, wherein the hazard score further comprises hazard output data associated with the determination of the hazard score.

13. The method of claim 11, wherein the hazard state is one of a plurality of discrete classifications.

14. The method of claim 13, wherein each of the plurality of discrete classifications is associated with a different visual indication.

15. The method of claim 11, wherein the site data further comprises auxiliary data, and wherein the determination of the hazard score is further based at least in part on the auxiliary data, wherein the auxiliary data comprises at least one of hazardous event data or weather data.

16. The method of claim 11, wherein the first subset of entities comprise static entities and dynamic entities that are located outside of the hazard zone.

17. The method of claim 11, wherein the hazard state for each hazard zone is determined independently.

18. The method of claim 11, wherein the determination of a hazard state for each hazard zone is determined using a machine learning model associated with the first hazard type.

19. The method of claim 18 further comprising:
accessing a second hazard overlay associated with the launch site, wherein the second hazard overlay divides at least a portion of the launch site into a plurality of hazard zones, wherein the second hazard overlay is associated with a second hazard type,
wherein the determination of a hazard state for each hazard zone associated with the second overlay is determined using a machine learning model associated with the second hazard type.

20. The method of claim 11, wherein the site data is received in real-time from the launch site, and the determination of a hazard state for each hazard zone is determined in real-time.
